(19) United States
(12) Patent Application Publication
(10) Pub. No.: US 2010/0044643 A1
(43) Pub. Date: Feb. 25, 2010

(54) Low NOx Gasification Startup System

(75) Inventor: Paul Steven Wallace, Katy, TX (US)

Correspondence Address: KING & SPALDING, LLP, 1100 LOUISIANA ST., STE. 4000, ATTN.: IP Docketing, HOUSTON, TX, 77002-5213, US

(73) Assignee: Hunton Energy Holdings, LLC, Houston, TX (US)

(21) Appl. No.: 12/353,737

(22) Filed: Jan. 14, 2009

Related U.S. Application Data
(60) Provisional application No. 61/090,973, filed on Aug. 22, 2008.

(51) Int. Cl. C01B 3/36; B01J 19/00; B01J 10/00

(52) U.S. Cl. 252/373; 422/129; 422/187

(57) ABSTRACT

Disclosed is a low NOₓ gasification startup system and a method for starting up a low NOₓ startup system. During startup of a gasification unit, a gasifier must be pre-heated via combustion of a fuel source, which thereby generates pollutants. Once pre-heated, the gasifier initially generates off-spec syngas that requires disposal via combustion, thereby generating additional pollutants. The low NOₓ gasification startup system substantially lowers emission rates of NOₓ, CO, and/or VOCs during the startup process. During normal operation of the gasification unit, O₂ and CO₂ may be produced, stored, and later used during startup processes. The stored O₂ and CO₂ may be sent to one or more combustion devices and utilized as an oxidant for combusting undesired gases during the startup process. This CO₂/O₂ mixture provides a higher oxygen content than air and contains substantially less nitrogen than air, thereby substantially reducing NOₓ formation within the combustion device's emissions.

### CROSS REFERENCE TO RELATED APPLICATIONS

The present application claims priority from U.S. Provisional Patent Application No. 61/090,973, entitled “Low NOₓ Gasification Startup System” and filed on Aug. 22, 2008. Additionally, the present application is related to U.S. patent application Ser. No. 12/351,515, entitled, “Power Management for Gasification Plants” and filed on Jan. 9, 2009, which is incorporated by reference in its entirety.

### TECHNICAL FIELD

This invention relates generally to methods and systems for reducing emissions within an industrial plant, and, more particularly, to methods and systems for reducing nitrous oxides (“NOₓ”), carbon monoxide (“CO”), and/or volatile organic compounds (“VOCs”) emissions during startup of an industrial plant, for example, a gasification plant.

### BACKGROUND

Environmental awareness is growing in the U.S. and around the world leading to increasing public and regulatory pressures to reduce pollutant emissions from boilers, pre-heaters, incinerators, furnaces, and thermal oxidizers. One pollutant of particular concern is NOₓ, by which is meant oxides of nitrogen such as but not limited to NO, NO₂, NO₃, N₂O, N₂O₃, N₂O₄, N₃O₄, and mixtures thereof. NOₓ is one of the main ingredients involved in the formation of ground-level ozone, which may trigger serious respiratory problems. Additionally, NOₓ reacts to form toxic chemicals, nitrate particles, acid aerosols, and NO₂, which also causes respiratory problems. Furthermore, NOₓ contributes to acid rain formation, nutrient overload that deteriorates water quality, atmospheric particles that may cause visibility impairment, and global warming. NOₓ and pollutants formed from NOₓ may be transported over long distances. The problems associated with NOₓ are therefore not confined only to areas where NOₓ is emitted.

Another pollutant of particular concern is CO, which is a colorless, odorless gas that is formed when carbon in fuel is not burned completely. CO is poisonous even to healthy people at high levels in the air by reducing oxygen delivery to the body's organs, for example, the heart and the brain. CO may affect people with heart disease, even with a single exposure at low levels. Additionally, CO may affect the central nervous system and cause vision problems, reduced ability to work or learn, reduced manual dexterity, and even death. Furthermore, CO contributes to the formation of ground-level ozone, or smog, which, as previously mentioned, may trigger serious respiratory problems. CO may be transported over long distances. The problems associated with CO are therefore not confined only to areas where CO is emitted.

Currently, and according to one example, the startup of a gasification unit produces high hourly NOₓ emissions from both the startup pre-heat burner and the thermal oxidation of the off-spec startup syngas in a startup thermal oxidizer, which uses air as the oxidant. Although the startup operating mode occurs infrequently, typically about less than 1% of the annual operating hours, these high NOₓ emissions during the startup may create a high hourly emissions rate of NOₓ and thus may impact short term, local air quality and other detrimental effects. This high hourly emissions rate may create costly monitoring requirements, trigger NOₓ cap and trade programs, and limit startup duration and frequency. Although an example related to the startup of a gasification unit has been provided, the example illustrates the concerns for various different types of industrial plants.

In view of the foregoing discussion, need is apparent in the art for reducing pollutant emissions, including but not limited to NOₓ, CO, and/or VOCs from boilers, pre-heaters, incinerators, furnaces, and thermal oxidizers. Additionally, a need is apparent for providing alternative oxidants other than air for use within boilers, pre-heaters, incinerators, furnaces, and thermal oxidizers. Further, there exists the need for reducing NOₓ, CO, and/or VOCs emissions from the startup of a gasification unit. A technology addressing one or more such needs, or some other related shortcoming in the field, would benefit processes utilizing at least one of boilers, pre-heaters, incinerators, furnaces, and thermal oxidizers, for example a gasification plant. This technology is included within the current invention.

### SUMMARY

According to one embodiment, a low NOₓ startup system comprises a combustion device, an O₂ stream entering the combustion device, and a CO₂ stream entering the combustion device. The O₂ stream and the CO₂ stream are combined to form a CO₂/O₂ mixture which comprises a CO₂ composition and an O₂ composition.

According to another embodiment, a low NOₓ startup system comprises an air separation system, an O₂ storage tank, an acid gas removal system, a CO₂ storage tank, and a combustion device. The air separation system produces a liquid O₂ and the acid gas removal system produces a liquid CO₂. The liquid O₂ flows from the air separation system into the O₂ storage tank, which stores the liquid O₂. The liquid CO₂ flows from the acid gas removal system into the CO₂ storage tank, which stores the liquid CO₂. The O₂ stream from the O₂ storage tank and a CO₂ stream from the CO₂ storage tank flow into the combustion device, wherein the O₂ stream and the CO₂ stream are combined to form a CO₂/O₂ mixture which comprises a CO₂ composition and an O₂ composition.

According to another embodiment, a method for starting up a low NOₓ startup system comprises providing a combustion device, providing an O₂ stream to the combustion device, and providing a CO₂ stream to the combustion device. The O₂ stream and the CO₂ stream are combined to form a CO₂/O₂ mixture which comprises a CO₂ composition and an O₂ composition.

According to another embodiment, a method for starting up a low NOₓ startup system comprises providing a first O₂ stream, a first CO₂ stream, and a natural gas stream to a pre-heat burner located within a gasification system and providing a second O₂ stream and a second CO₂ stream to a thermal oxidizer. The first O₂ stream, the first CO₂ stream, and the natural gas stream are reacted within the pre-heat burner to produce an effluent stream. Once the pre-heat burner is pre-heated to a desired temperature, the first O₂ stream and a coal/coke stream are provided into the gasification system to produce a scrubbed reacted gas stream. The scrubbed reacted gas stream is sent to a shift reactor system, where a substantial portion of water is removed from the scrubbed reacted gas stream, thereby producing a sour syngas stream. The sour syngas stream is then sent to a thermal oxidizer. In the thermal oxidizer, the second O₂ stream, the second CO₂ stream, and the sour syngas stream are reacted to produce a first thermal oxidizer discharge stream. Once the shift reactor system reaches a first desired pressure, the sour syngas stream is sent to an acid gas removal system to produce an off-spec syngas stream. This off-spec syngas stream is then sent to the thermal oxidizer. Within the thermal oxidizer, the second O₂ stream, the second CO₂ stream, and the off-spec syngas stream are reacted to produce a second thermal oxidizer discharge stream. Once the acid gas removal system reaches a second desired pressure, a spec syngas stream is produced.

### BRIEF DESCRIPTION OF THE DRAWINGS

The foregoing and other features and aspects of the invention may be best understood with reference to the following description of certain exemplary embodiments of the invention, when read in conjunction with the accompanying drawings, wherein:

FIG. 1 shows a flowchart of a gasification unit in accordance with an exemplary embodiment;

FIG. 2 shows a flowchart of a low NOₓ gasifier startup system incorporated with the gasification unit of FIG. 1 which uses a carbon dioxide/oxygen (“CO₂/O₂”) mixture as the oxidant in accordance with an exemplary embodiment;

FIG. 3 shows a flowchart of a gasifier system as shown in the low NOₓ gasifier startup system of FIG. 2 in accordance with an exemplary embodiment;

FIG. 4 shows a flowchart of a shift reactor system as shown in the low NOₓ gasifier startup system of FIG. 2 in accordance with an exemplary embodiment;

FIG. 5 shows a flowchart of an acid gas removal system as shown in the low NOₓ gasifier startup system of FIG. 2 in accordance with an exemplary embodiment;

FIG. 6A shows a table providing flow specifications and hourly max emissions during the startup of the gasification unit while using an air oxidant;

FIG. 6B shows a table providing natural gas compositions used for obtaining the table of FIG. 6A;

FIG. 7A shows a table providing flow specifications and hourly max emissions during the startup of the gasification unit while using a CO₂/O₂ oxidant in accordance with an exemplary embodiment; and

FIG. 7B shows a table providing natural gas compositions used for obtaining the table of FIG. 7A in accordance with an exemplary embodiment.

The drawings illustrate only exemplary embodiments of the invention and are therefore not to be considered limiting of its scope, as the invention may admit to other equally effective embodiments.

### BRIEF DESCRIPTION OF EXEMPLARY EMBODIMENTS

The application is directed to methods and systems for reducing emissions within an industrial plant, for example, a gasification plant. In particular, the application is directed to reducing NOₓ, CO, and/or VOCs emissions during startup of an industrial plant, for example, a gasification plant. Although the description of an exemplary embodiment of the invention is provided below in conjunction with a gasification unit, embodiments of the invention may be applicable to any industrial plant that has NOₓ, CO, and/or VOCs emissions from anyone of boilers, pre-heaters, incinerators, furnaces, and thermal oxidizers, including but not limited to any type of gasification plant.

The invention may be better understood by reading the following description of non-limiting, exemplary embodiments with reference to the attached drawings, wherein like parts of each of the figures are identified by the same reference characters, and which are briefly described as follows.

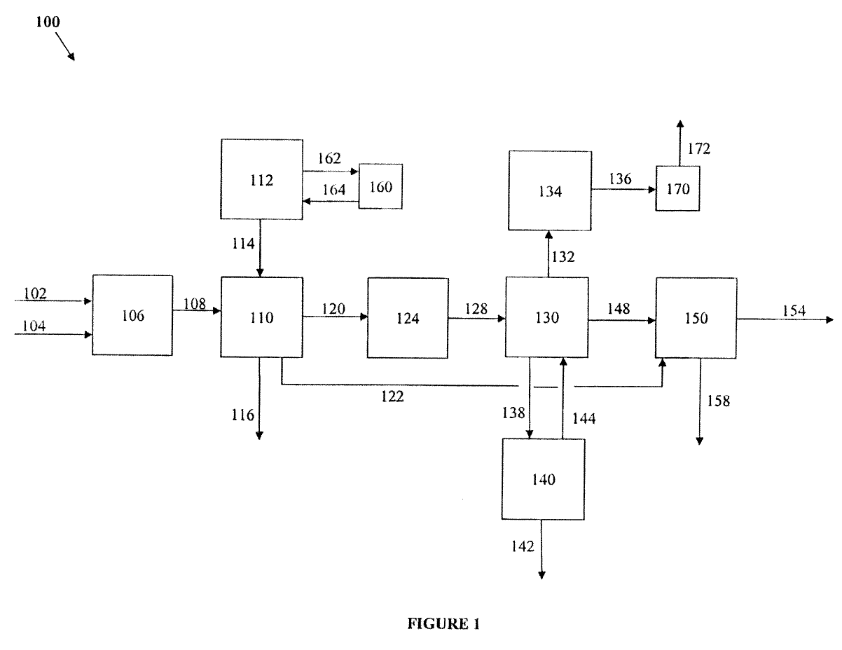

FIG. 1 shows a flowchart of a gasification unit 100 in accordance with an exemplary embodiment. Although one having ordinary skill in the art would realize that there are many equipment and process and non-process lines in the gasification unit 100, only certain key equipment and process and non-process lines relevant to the exemplary embodiment of the invention are illustrated in FIG. 1.

The gasification unit 100 comprises a coke feed stream 102 at about 9,500 tons per day (TPD) and a biomass feed stream 104 at about 500 TPD. The coke feed stream 102 and the biomass feed stream 104 enter a slurry preparation system 106 (5 units at 25% capacity, or 5×25%), which produces a slurry stream 108. The slurry stream 108 may be formed by grinding or by any other means known to one having ordinary skill in the art. The slurry stream 108 then enters a gasifier system 110 (4×30%). Although specific flow rates, number of units, and capacity for the coke feed stream 102, the biomass feed stream 104, the slurry preparation system 106, and the gasifier system 110 have been illustrated, alternative flow rates, number of units, and capacity may be used without departing from the scope and spirit of the exemplary embodiment. Additionally, in alternative embodiments, the coke feed stream 102 and the biomass feed stream 104 may be replaced with other suitable feed streams, such as hazardous waste, hydrocarbon streams, carbohydrate-based compounds, coal, and municipal waste, without departing from the scope and spirit of the exemplary embodiment.

An air separation system 112 (3×40% or 2×60%) separates air into at least a nitrogen (“N₂”) component and an oxygen (“O₂”) component. Some of the O₂ component exits the air separation system 112 as liquid O₂ via an O₂ storage supply stream 162 and enters a liquid O₂ storage tank 160. Liquid O₂ may be recycled back to the air separation system 112 from the liquid O₂ storage tank 160 via an O₂ storage return stream 164. Within the air separation unit 112, at least a portion of the liquid O₂ is converted into a vapor O₂ that flows through an air separation outlet stream 114. Also, liquid O₂ stored within the liquid O₂ storage tank 160 may be used in other areas of the gasification unit 100, for example, during startup processes or even sold. Additionally, the air separation system 112 may also directly provide the air separation outlet stream 114, which comprises mainly of vapor O₂, at about 11,000 TPD to the gasifier system 110. The use of the oversized air separation system 112 may result in an increase in overall production. Although specific flow rates, number of units, and capacity for the air separation outlet stream 114 and the air separation system 112 have been illustrated, alternative flow rates, number of units, and capacity may be used without departing from the scope and spirit of the exemplary embodiment. Alternatively, although the process has been described as having the air separation system 112 fill the liquid O₂ storage tank 160 with liquid O₂, the liquid O₂ storage tank 160 may be filled from external supply sources without departing from the scope and spirit of the exemplary embodiment. This liquid O₂ storage provides increases the gasification unit's 100 reliability.

The gasifier system 110 produces a slag stream 116 and a gasifier system outlet stream 120. The slag stream 116 may comprise metals naturally occurring in the coke and biomass feed streams 102, 104, and added minerals to control the melting point of the slag stream 116. The slag stream 116 may be utilized as an aggregate in concrete manufacturing and/or the manufacturing of other materials.

The gasifier system outlet stream 120 comprises about 35% CO, about 15% hydrogen (“H₂”), about 40% water (“H₂O”), and about 10% carbon dioxide (“CO₂”). The conversion of the slurry stream 108 and the air separation outlet stream 114 into the slag stream 116 and the gasifier system outlet stream 120 is an exothermic process and as a result, a high pressure saturated steam stream 122 also is produced. Although specific compositions have been provided for the gasifier system outlet stream 120, alternative compositions may be achieved without departing from the scope and spirit of the exemplary embodiment.

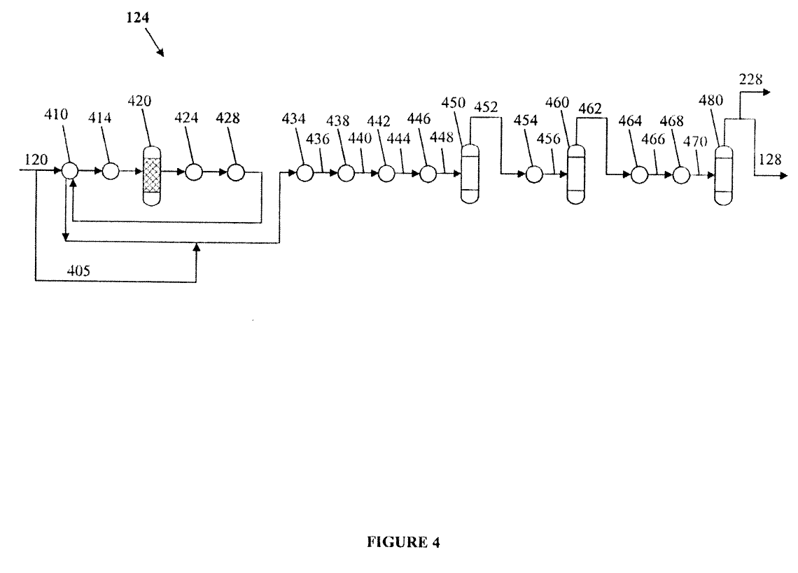

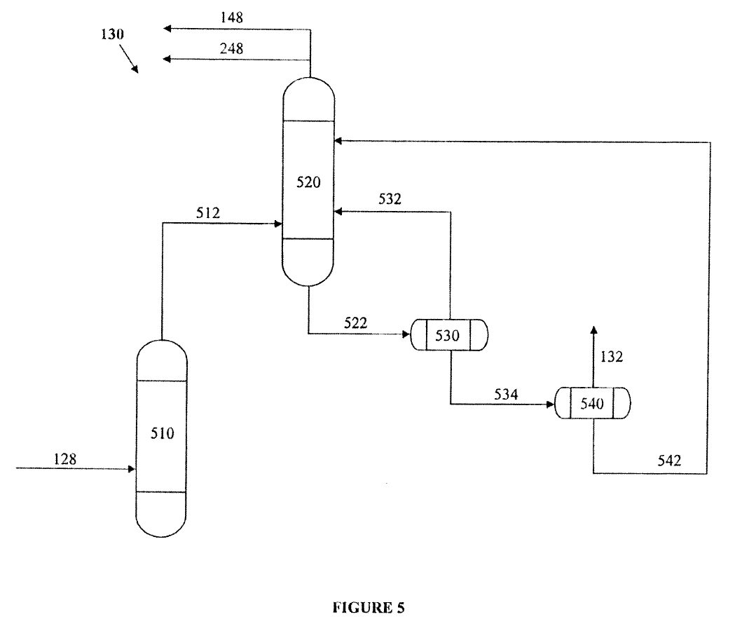

The gasifier system outlet stream 120 enters a shift reactor system 124 (4×30%). The shift reactor system 124 comprises at least one catalytic shift reactor 420 (FIG. 4) that converts the gasifier system outlet stream 120 into a shift reactor system outlet stream 128. Specifically, the shift reactor system 124 produces more H₂ and CO₂ by reacting the H₂O with the CO. The shift reactor system outlet stream 128 comprises about 15% CO, about 45% H₂, and about 40% CO₂. In certain embodiments, the shift reactor system 124 includes gas cooling capabilities. Although specific compositions, number of units, and capacity have been provided for the shift reactor system outlet stream 128 and the shift reactor system 124, alternative compositions, number of units, and capacity may be achieved without departing from the scope and spirit of the exemplary embodiment.

The shift reactor system outlet stream 128 then enters an acid gas removal system 130 (2×50%). The acid gas removal system 130 may utilize Selexol™ for hydrogen sulfide (“H₂S”) removal and CO₂ capture. As a result, a vapor CO₂ stream 132 at about 22,000 TPD is produced. The vapor CO₂ stream 132 is compressed in a CO₂ compressor system 134, which includes a CO₂ refrigeration exchanger (not shown), and the resulting high pressure liquid CO₂ stream 136 may be sent to a liquid CO₂ storage tank 170. From the liquid CO₂ storage tank 170, the liquid CO₂ may then be utilized for enhanced oil recovery (EOR) (not shown) via EOR stream 172 by pumping the liquid CO₂ into the ground to increase the production of oil. Also, liquid CO₂ from the liquid CO₂ storage tank 170 may be used in other areas of the gasification unit 100, for example, during startup processes or even sold. Alternatively, although the process has been described as having the acid gas removal system 130 fill the liquid CO₂ storage tank 170 with liquid CO₂, the liquid CO₂ storage tank 170 may be filled from external supply sources without departing from the scope and spirit of the exemplary embodiment. This liquid CO₂ storage provides the ability to operate the unit in case the compression or pipeline is unable to receive the CO₂, thereby increasing the gasification unit's 100 reliability. Although specific flow rates, number of units, and capacity have been provided for the vapor CO₂ stream 132 and the acid gas removal system 130, alternative flow rates, number of units, and capacity may be achieved without departing from the scope and spirit of the exemplary embodiment.

The acid gas removal system 130 also produces an acid gas stream 138. The acid gas stream 138 enters a sulfur recovery system 140 (3×50%) to produce a sulfur stream 142 and a recycle tail gas stream 144. The sulfur stream 142 comprises sulfur and may be sold to fertilizer plants and the like. The recycle tail gas stream 144 comprises some sulfur and is recycled back into the acid gas removal system 130.

The acid gas removal system 130 also produces an acid gas removal system outlet stream 148 comprising mainly of CO and H₂. Since the CO₂ has been removed within the acid gas removal system 130, the acid gas removal system outlet stream 148 comprises about 25% CO and about 75% H₂. In certain embodiments, the acid gas removal system outlet stream 148 may be sold as syngas to market or consumed by other systems requiring the syngas (not shown). The syngas may be used as ammonia, methanol, or hydrogen, or be utilized in the production of power or chemicals. Although specific compositions, number of units, and capacity have been provided for the acid gas removal system outlet stream 148 and the sulfur recovery system 140, alternative compositions, number of units, and capacity may be achieved without departing from the scope and spirit of the exemplary embodiment.

The acid gas removal system outlet stream 148 may then enter a methanation system 150 (2×50%), which includes one or more methanation reactors (not shown). The methanation system 150 converts the acid gas removal system outlet stream 148 into a methanation system outlet stream 154. The methanation system outlet stream 154 comprises SNG at about 180 million standard cubic feet per day of gas (MMSCFD) and may be sold to market or consumed by other systems requiring the syngas. In certain alternative embodiments, a portion of the methanation system outlet stream 154 may enter combustion turbines (not shown) to produce power to be sold to market. Although specific flow rates, number of units, and capacity have been provided for the methanation system outlet stream 154 and the methanation system 150, alternative flow rates, number of units, and capacity may be achieved without departing from the scope and spirit of the exemplary embodiment.

In addition, the high pressure saturated steam stream 122 from the gasifier system 110 may enter the methanation system 150. The conversion of the acid gas removal system outlet stream 148 into the methanation system outlet stream 154 in the methanation system 150 is an exothermic reaction and as a result, the high pressure saturated steam stream 122 is converted to a high pressure superheated steam stream 158 at about 2,800 kilo pounds per hour (“kpph”). The high pressure superheated steam stream 158 may be utilized in a steam turbine (1×120%) (not shown) to produce power to be sold to market or consumed by other systems requiring the power. Although specific flow rates for the high pressure superheated steam stream 158 and specific number of units and capacity for the steam turbine (not shown) have been illustrated, alternative flow rates, number of units, and capacity may be achieved without departing from the scope and spirit of the exemplary embodiment.

In the exemplary embodiment of the gasification unit 100, the largest consumers of power or refrigeration needs are the air separation system 112, the acid gas removal system 130, and the CO₂ compressor system 134 for the compressing and cooling of the vapor CO₂ stream 132. This process has been described in greater detail in U.S. patent application Ser. No. 12/351,515, entitled, “Power Management for Gasification Plants” and filed on Jan. 9, 2009, which has been incorporated by reference in its entirety.

During occasional circumstances, for example, plant maintenance or plant modifications, the gasification unit 100 may be shutdown so that the appropriate work may be performed. Upon completion of the modifications and/or maintenance, the gasification unit 100 must proceed through a startup wherein certain systems within the gasification unit 100 are started up in a systematic order. During this startup procedure, the off-spec, low pressure synthetic natural gas (“off-spec syngas”) that is produced must be disposed of within a startup thermal oxidizer. Although a startup thermal oxidizer is described as being used, any other combustion device, including but not limited to a startup flare, may be used without departing from the scope and spirit of the exemplary embodiment. According to prior art technology, during the startup process of a gasification unit, combustion of gases typically occur within a startup pre-heat burner and the startup thermal oxidizer while using air as the oxidant, which thereby results in increased NOₓ and/or CO emissions from both devices.

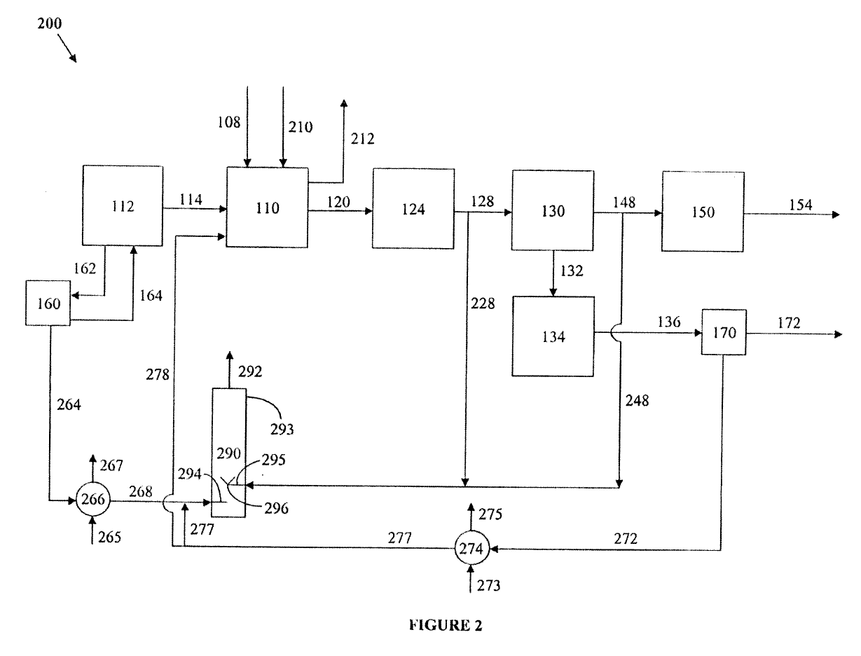

FIG. 2 shows a flowchart of a low NOₓ gasifier startup system 200 incorporated with the gasification unit 100 of FIG. 1 which uses a CO₂/O₂ mixture as the oxidant in accordance with an exemplary embodiment. By using the CO₂/O₂ mixture as the oxidant, and not air, substantially reduced emissions of NOₓ, CO, and/or VOCs occur within both above-mentioned devices. Although one having ordinary skill in the art would realize that there are many equipment and process and non-process lines in the low NOₓ gasifier startup system 200, only certain key equipment and process and non-process lines relevant to the exemplary embodiment of the invention are illustrated in FIG. 2.

The description of FIG. 2 is provided in relation to the startup process for the gasification unit 100 (FIG. 1). As seen in FIG. 2 and previously mentioned above, the liquid O₂ storage tank 160 stores liquid O₂ for at least in the use in the startup process. Additionally, the liquid CO₂ storage tank 170 stores liquid CO₂ for at least in the use in the startup process. Hence, a CO₂/O₂ mixture is used as the oxidant, instead of air, for the combustion of gases during the startup process.

The liquid O₂ within the liquid O₂ storage tank 160 has been accumulated from the air separation system 112, which separates air into at least a N₂ component and a O₂ component. During the gasification unit's 100 (FIG. 1) normal operation, some of the O₂ component exits the air separation system 112 as liquid O₂ via the O₂ storage supply stream 162 and enters the liquid O₂ storage tank 160. As later described, the liquid O₂ within the liquid O₂ storage tank 160 maybe used during the gasification unit's 100 (FIG. 1) startup process. Alternatively, vapor O₂ from the air separation system 112 may be used during the gasification unit's 100 (FIG. 1) startup process.

The liquid CO₂ within the liquid CO₂ storage tank 170 has been accumulated from the acid gas removal system 130, which captures the CO₂ from the shift reactor system outlet stream 128, and the CO₂ compressor system 134. During the gasification unit's 100 (FIG. 1) normal operation, the captured CO₂ exits the acid gas removal system 130 via the vapor CO₂ stream 132 and is compressed and cooled to a liquid within the CO₂ compressor system 134. The resulting high pressure liquid CO₂ stream 136 is then sent to the liquid CO₂ storage tank 170. As later described, the liquid CO₂ within the liquid CO₂ storage tank 170 may be used during the gasification unit's 100 (FIG. 1) startup process. Alternatively, vapor CO₂ from the acid gas removal system 130 may be used during the gasification unit's 100 (FIG. 1) startup process. Additionally, and as previously mentioned, the liquid CO₂ within the liquid CO₂ storage tank 170 may be utilized for EOR (not shown) via EOR stream 172 by pumping the liquid CO₂ into the ground to increase the production of oil.

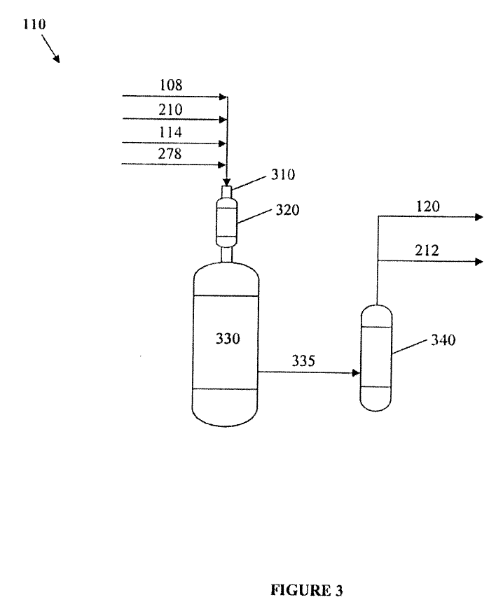

In describing the startup process for the gasification unit 100 (FIG. 1), each of FIGS. 2-5 will be referenced. FIG. 3 shows a flowchart of a gasifier system 110 as shown in the low NOₓ gasifier startup system 200 of FIG. 2 in accordance with an exemplary embodiment. FIG. 4 shows a flowchart of a shift reactor system 124 as shown in the low NOₓ gasifier startup system 200 of FIG. 2 in accordance with an exemplary embodiment. FIG. 5 shows a flowchart of an acid gas removal system 130 as shown in the low NOₓ gasifier startup system 200 of FIG. 2 in accordance with an exemplary embodiment.

Now referring to FIG. 2 and FIG. 3, during the startup process, liquid O₂ may be recycled back through a portion of the air separation system 112 from the liquid O₂ storage tank 160 via the O₂ storage return stream 164. Within the air separation unit 112, at least a portion of the liquid O₂ is converted into a vapor O₂, which then exits the air separation unit 112 via the air separation outlet stream 114. The air separation outlet stream 114 then enters the gasifier system 110 through a startup pre-heat burner 310, which may be similar to a removable nozzle coupled to a gasifier reactor 320. Although the described process illustrates that the liquid O₂ is sent from the liquid O₂ storage tank 160 to the startup pre-heat burner 310 via at least a portion of the air separation system 112, the liquid O₂ may be sent to the startup pre-heat burner 310 via alternative piping configurations without departing from the scope and spirit of the exemplary embodiment. Also, liquid O₂ may exit the liquid O₂ storage tank 160 via a liquid O₂ discharge stream 264 and proceed into an O₂ heat exchanger 266. The O₂ heat exchanger 266 provides heat to the liquid O₂ discharge stream 264, thereby causing an O₂ oxidizer supply stream 268 to exit the O₂ heat exchanger 266 and enter the bottom portion of a startup thermal oxidizer 290. The O₂ heat exchanger 266 operates on a heating fluid entering the O₂ heat exchanger 266 via a O₂ heat exchanger inlet stream 265 and exiting the O₂ heat exchanger 266 via a O₂ heat exchanger outlet stream 267. According to some exemplary embodiments, the heating fluid is steam or hot water. However, alternative heating fluids may be used within the O₂ heat exchanger 266 in different embodiments without departing from the scope and spirit of the exemplary embodiment.

Also during the startup process, liquid CO₂ may exit the liquid CO₂ storage tank 170 via a liquid CO₂ discharge stream 272 and proceed into a CO₂ heat exchanger 274. The CO₂ heat exchanger 274 provides heat to the liquid CO₂ discharge stream 272, thereby causing a CO₂ oxidizer supply stream 277 to exit the CO₂ heat exchanger 274 and enter the bottom portion of the startup thermal oxidizer 290. Additionally, a CO₂ gasifier supply stream 278 branches off of the CO₂ oxidizer supply stream 277 and enters the gasifier system 110 through the startup pre-heat burner 310. Although the described process illustrates that the CO₂ gasifier supply stream 278 branches off of the CO₂ oxidizer supply stream 277, alternative piping configurations may be used without departing from the scope and spirit of the exemplary embodiment. The CO₂ heat exchanger 274 operates on a heating fluid entering the CO₂ heat exchanger 274 via a CO₂ heat exchanger inlet stream 273 and exiting the CO₂ heat exchanger 274 via a CO₂ heat exchanger outlet stream 275. According to some exemplary embodiments, the heating fluid is steam or hot water. However, alternative heating fluids may be used within the CO₂ heat exchanger 274 in different embodiments without departing from the scope and spirit of the exemplary embodiment.

Although this embodiment illustrates that liquid O₂ is delivered to the startup pre-heat burner 310 and the startup thermal oxidizer 290 via the liquid O₂ storage tank 160, some embodiments may deliver vapor O₂ to the startup pre-heat burner 310 and the startup thermal oxidizer 290 directly from the air separation system 112 without departing from the scope and spirit of the exemplary embodiment. Additionally, although this embodiment illustrates that liquid CO₂ is delivered to the startup pre-heat burner 310 and the startup thermal oxidizer 290 via the liquid CO₂ storage tank 170, some embodiments may deliver vapor CO₂ to the startup pre-heat burner 310 and the startup thermal oxidizer 290 directly from the acid gas removal system 130 without departing from the scope and spirit of the exemplary embodiment.

As illustrated above, a CO₂/O₂ mixture, instead of a nitrogen-containing air, is provided to both the startup pre-heat burner 310 of the gasifier system 110 and the startup thermal oxidizer 290 during the startup process and behaves as an oxidant during the combustion of gases. This CO₂/O₂ mixture is approximately 78% CO₂ and approximately 22% O₂. There may be some impurities, approximately less than 1%, within this mixture, for example, Argon. Another impurity that may be found within this CO₂/O₂ mixture is nitrogen, but at reduced concentrations of about less than 0.2%. This nitrogen concentration is substantially less than the concentration of nitrogen found within air, which is about 78%. It follows that since there is less nitrogen within the CO₂/O₂ mixture, less NOₓ will be formed during combustion. Although concentration percentages have been provided for the CO₂/O₂ mixture, alternative composition percentages may be utilized without departing from the scope and spirit of the exemplary embodiment. For example only, the concentration of CO₂ may range from approximately 65% to approximately 85%, while the concentration of O₂ may range from approximately 15% to approximately 35%.

During start-up of the gasification unit 100 (FIG. 1), the gasifier reactor 320 is initially pre-heated to a desired temperature prior to allowing the slurry stream 108 to enter the gasifier reactor 320. In one embodiment, the desired temperature is the temperature for initiating the reaction within the gasifier reactor 320. In one example, the temperature for initiating the reaction is about 2500° F. During startup, natural gas is used to pre-heat the gasifier reactor 320. Thus, CO₂, O₂, and a natural gas are supplied to the startup pre-heat burner 310 via the CO₂ gasifier supply stream 278, the air separation outlet stream 114, and a natural gas stream 210, respectively. The startup pre-heat burner 310 and the gasifier reactor 320 are both closed chambers that thereby prevent the nitrogen-containing ambient air from entering the gasifier reactor 320. Since there is none to very little nitrogen entering the startup pre-heat burner 310, it follows that there is none to very little NOₓ that is formed during this step in the startup process. During this pre-heating of the gasifier reactor 320, a pre-heat exhaust stream 212 is created, which exits the gasifier system 212. This pre-heat exhaust stream 212 is discharged into the atmosphere, according to one embodiment, and contains a reduced amount of emissions.

Once the temperature within the gasifier reactor 320 reaches to about the desired temperature, which may be about 2500° F., the startup pre-heat burner 310 is removed and replaced with a feed injector (not shown). At this time, the natural gas feed from the natural gas stream 210, the CO₂ feed from the CO₂ gasifier supply stream 278, and the O₂ feed from the air separation outlet stream 114 are turned off. A vacuum is then created within the entire system to remove the excess O₂ so that an explosion hazard is not created when the syngas is formed. Once the excess O₂ has been removed from the system, the coal and coke feed from the slurry stream 108 and the O₂ from the air separation outlet stream 114 is allowed to enter the feed injector (not shown). However, a reduced amount of O₂ is allowed to enter the feed injector (not shown) so that there is no excess O₂. Thus, now O₂ and the coal/coke are supplied to the feed injector (not shown) via the air separation outlet stream 114 and the slurry stream 108, respectively. Since the temperature within the gasifier reactor 320 is about at the desired temperature, the reaction of the feed streams initiates. According to one embodiment, the gasifier reactor 320 operates in a range from about 650 psig to about 800 psig and at about 2500° F. Although exemplary pressures and temperatures have been provided for the operating conditions of the gasifier reactor 320, alternative operating pressures and temperatures may be used without departing from the scope and spirit of the exemplary embodiment.

Upon reacting within the gasifier reactor 320, the reacted gases, or off-spec syngas, enter into a radiant cooler 330, which may be coupled to the gasifier reactor 320. The radiant cooler 330 cools the off-spec syngas exiting the gasifier reactor 320 and produces steam, that also contains particulates, which then exits the radiant cooler 330 via a radiant cooler discharge stream 335. The radiant cooler discharge stream 335 then enters a scrubber 340. Although one type of gasifier has been illustrated, alternative types of gasifiers, including, but not limited to quench gasifiers, may be used without departing from the scope and spirit of the exemplary embodiment.

The scrubber 340 performs as a wet column wherein the particulates within the radiant cooler discharge stream 335 are washed out. Thus, the scrubbed off-spec syngas exits the scrubber 340 via the gasifier system outlet stream 120. The scrubbed off-spec syngas is saturated when it exits the scrubber 340. Since the heating value of the scrubbed off-spec syngas is poor due to the great amount of water present within the scrubbed off-spec syngas, the water should be substantially removed prior to sending the off-spec syngas into a combustion device, or a start-up thermal oxidizer 290. As seen in FIG. 3, the pre-heat exhaust stream 212 exits the gasifier system 110 from the scrubber 340.

Now referring to FIG. 2 and FIG. 4, to substantially remove the water present within the gasifier system outlet stream 120, the gasifier system outlet stream 120 enters one or more coolers and one or more knockout drums located within the shift reactor system 124. During the start-up process and in accordance with one of the exemplary embodiments, the scrubbed off-spec syngas within the gasifier system outlet stream 120 bypasses a feed/product exchanger 410, a trim heater 414, a catalytic shift reactor 420, a high pressure superheated steam exchanger 424, and a high pressure eco exchanger 428, and enters a medium pressure boiler 434 via a bypass stream 405. Some reasons for bypassing the catalytic shift reactor 420 includes, but is not limited to, not desiring to contaminate the catalyst within the catalytic shift reactor 420 and not desiring additional pressure drop to occur within the shift reactor system 124 when trying to get the pressure within the shift reactor system 124 to a certain minimum threshold. Although the exchangers and catalytic reactor are bypassed in accordance with one embodiment, other embodiments may not have a bypass stream without departing from the scope and spirit of the exemplary embodiment.

The bypass stream 405 may be cooled within the medium pressure boiler 434 and exits the medium pressure boiler via a medium pressure boiler discharge stream 436. The medium pressure boiler discharge stream 436 may then enter a process condensate heater 438, become further cooled, and exit the process condensate heater 438 via the process condensate heater discharge stream 440. The process condensate heater discharge stream 440 may then enter a grey water heater 442, become further cooled, and exit the grey water heater 442 via the grey water heater discharge stream 444. The grey water heater discharge stream 444 may then enter a low pressure boiler 446, become further cooled, and exit the low pressure boiler 446 via the low pressure boiler discharge stream 448.

The low pressure boiler discharge stream 448 may then enter a first knockout drum 450, wherein the liquid phase and the vapor phase of the low pressure boiler discharge stream 448 are separated. The vapor phase of the low pressure boiler discharge stream 448 exits the first knockout drum 450 via a first knockout drum vapor stream 452. The first knockout drum vapor stream 452 may then enter a first steam condensate heater 454, wherein the vapor is cooled and exits the first steam condensate heater 454 via a first steam condensate heater discharge stream 456. The first steam condensate heater discharge stream 456 may then enter a second knockout drum 460, wherein the liquid phase and the vapor phase of the first steam condensate heater discharge stream 456 are separated. The vapor phase of the first steam condensate heater discharge stream 456 exits the second knockout drum 460 via a second knockout drum vapor stream 462. The second knockout drum vapor stream 462 may then enter a second steam condensate heater 464, wherein the vapor is further cooled and exits the second steam condensate heater 464 via a second steam condensate heater discharge stream 466. The second steam condensate heater discharge stream 466 may then enter a cooling water exchanger 468 for further cooling, and then exit the cooling water exchanger 468 via a cooling water exchanger discharge stream 470. The cooling water exchanger discharge stream 470 may then enter a third knockout drum 480, wherein the liquid phase and the vapor phase of the cooling water exchanger discharge stream 470 are separated. The vapor phase of the cooling water exchanger discharge stream 470 exits the third knockout drum 480 via either a shift reactor system off-spec gas stream 228 or the shift reactor system outlet stream 128. Although many exchangers and knockout drums have been described within the shift reactor system 124, fewer or greater exchangers and/or knockout drums may be used without departing from the scope and spirit of the exemplary embodiment.

During the startup process, the vapor phase of the cooling water exchanger discharge stream 470 exits the third knockout drum 480 via the shift reactor system off-spec gas stream 228. This shift reactor system off-spec gas stream 228, which may also be referred to as sour syngas, is sent to the startup thermal oxidizer 290 for combustion. Once the vapor phase of the cooling water exchanger discharge stream 470 reaches a minimum threshold of pressure, the vapor phase of the cooling water exchanger discharge stream 470 exits the third knockout drum 480 via the shift reactor system outlet stream 128, instead of the shift reactor system off-spec gas stream 228, and proceeds to the acid gas removal system 130 so that CO₂ may be captured and sulfur may be removed.

Now referring to FIG. 2 and FIG. 5, to substantially capture the CO₂ and remove the sulfur within the shift reactor system outlet stream 128, the shift reactor system outlet stream 128 may enter a sulfur absorber 510. The sulfur absorber removes the sulfur from the bottoms portion of the sulfur absorber 510. The off-spec syngas containing a reduced concentration of sulfur exits the sulfur absorber 510 through the top portion via a sulfur absorber discharge stream 512. The sulfur absorber discharge stream 512 may then enter a CO₂ absorber 520 for capturing the CO₂ present within the sulfur absorber discharge stream 512.

The CO₂ is separated from the sulfur absorber discharge stream 512 within the CO₂ absorber 520 and exits the bottom portion of the CO₂ absorber 520 via a CO₂ absorber bottoms discharge 522. The CO₂ absorber bottoms discharge 522 may enter a first separator 530, wherein a vapor phase and a liquid phase of the CO₂ absorber bottoms discharge 522 are separated. The vapor phase of the CO₂ absorber bottoms discharge 522 exits the first separator 530 via a first separator vapor discharge 532, which is then recycled back to the bottom portion of the CO₂ absorber 520. The liquid phase of the CO₂ absorber bottoms discharge 522 exits the first separator 530 via a first separator liquid discharge 534, which may then be sent to a second separator 540. The second separator 540 separates a vapor phase and a liquid phase of the first separator liquid discharge 534. The vapor phase of the first separator liquid discharge 534 exits the second separator 540 via the vapor C₂ stream 132, which comprises mainly of CO₂ and proceeds in a manner as described with respect to FIG. 2. The liquid phase of the first separator liquid discharge 534 exits the second separator 540 via a second separator liquid discharge 542, which is then recycled back to the top portion of the CO₂ absorber 520.

The off-spec syngas containing low concentrations of sulfur and CO₂ exits the top portion of the CO₂ absorber 520, as a vapor, via either an acid gas removal system off-spec gas stream 248 or the acid gas removal system outlet stream 148. During the startup process, the off-spec syngas containing low concentrations of sulfur and CO₂ exits the top portion of the CO₂ absorber 520 via the acid gas removal system off-spec gas stream 248. This acid gas removal system off-spec gas stream 248 is sent to the startup thermal oxidizer 290 for combustion. Once the off-spec syngas containing low concentrations of sulfur and CO₂ reaches a minimum threshold of pressure and becomes on-spec syngas, the on-spec syngas containing low concentrations of sulfur and CO₂ exits the CO₂ absorber 520 via the acid gas removal system outlet stream 148 and proceeds to the methanation system 150 for further processing to produce the methanation system outlet stream 154. Once the acid gas removal system 130 produces on-spec syngas, the syngas is on-spec throughout the rest of the process.

As shown in FIG. 2 and as previously mentioned, the shift reactor system off-spec gas stream 228 and the acid gas removal system off-spec gas stream 248 flow into the startup thermal oxidizer 290, where the streams 228, 248 undergo a combustion process using the CO₂/O₂ mixture. These streams 228, 248 have little to no NOₓ since the combustion occurring within the feed injector (not shown) is performed using the CO₂/O₂ mixture as the oxidant, which contains little to no nitrogen. Thus, without nitrogen, NOₓ gases are prevented from being formed within these streams 228, 248. Also, as previously stated, the CO₂/O₂ mixture is provided to the startup thermal oxidizer 290 via the O₂ oxidizer supply stream 268 and the CO₂ oxidizer supply stream 277. Similar to the combustion process taking place in the startup pre-heat burner 310, the combustion process occurring within the startup thermal oxidizer 290 produces little to no NOₓ. Since little to no nitrogen is contained within the CO₂/O₂ mixture and there is little to no nitrogen or NOₓ contained within the streams 228, 248, NOₓ gases are prevented and/or significantly reduced from being formed within a startup thermal oxidizer discharge stream 292, which is discharged into the atmosphere.

According to one embodiment, the startup thermal oxidizer 290 comprises a vertically oriented pipe 293, a CO₂/O₂ mixture inlet piping 294, an off-spec syngas inlet piping 295, at least one burner 296 containing the off-spec syngas that is to be combusted, and at least one pilot burner (not shown). The vertically oriented pipe 293 is designed to withstand the operating conditions, for example, temperature conditions, occurring during the combustion of the shift reactor system off-spec gas stream 228 and the acid gas removal system off-spec gas stream 248. Additionally, the length of the vertically oriented pipe 293 is determined to be sufficient to allow all reactions to take place within the vertically oriented pipe 293, prior to emitting the gases via the startup thermal oxidizer discharge stream 292, and to be sufficient so that the gases may be discharged in a manner that does not injure nearby personnel. The CO₂/O₂ mixture inlet piping 294 is piping oriented within the vertically oriented pipe 293 and is used to assist in uniformly discharging the CO₂/O₂ mixture within the bottom portion of the vertically oriented pipe 293. The off-spec syngas inlet piping 295 is piping oriented within the vertically oriented pipe 293 and is used to assist in uniformly discharging the off-spec syngas within the bottom portion of the vertically oriented pipe 293. The at least one burner 296 discharges the off-spec syngas that is to be combusted. The at least one pilot burner (not shown) may be natural gas fired and is used for producing a flame on the at least one burner 296. Although a pilot burner has been illustrated in this embodiment, other lighting mechanisms, including, but not limited to electronic igniters, may be used without departing from the scope and spirit of the exemplary embodiment.

According to some embodiments, however, the CO₂/O₂ mixture inlet piping 294 may be optional in that the CO₂/O₂ mixture may be discharged at the inner perimeter of the vertically oriented pipe 293. As the CO₂/O₂ mixture enters into the vertically oriented pipe 293, the CO₂/O₂ mixture is immediately vaporized due to the pressure differential. Also, although FIG. 2 depicts the O₂ oxidizer supply stream 268 and the CO₂ oxidizer supply stream 277 combining prior to entering the startup thermal oxidizer 290, the O₂ oxidizer supply stream 268 and the CO₂ oxidizer supply stream 277 may enter the startup thermal oxidizer 290 independently of one another. Additionally, although FIG. 2 depicts the shift reactor system off-spec gas stream 228 and the acid gas removal system off-spec gas stream 248 combining prior to entering the startup thermal oxidizer 290, the shift reactor system off-spec gas stream 228 and the acid gas removal system off-spec gas stream 248 may enter the startup thermal oxidizer 290 independently of one another.

In still yet additional embodiments, the startup thermal oxidizer 290 may further comprise one or more monitors (not shown) located at or near the top portion of the startup thermal oxidizer 290. These one or more monitors (not shown) analyze how much of a certain gas is being emitted from the startup thermal oxidizer 290 via the startup thermal oxidizer discharge stream 292. For example, the one or more monitors (not shown) may determine how much NOₓ, sulfur, CO, and/or volatile organic compounds (“VOCs”) that are being emitted from the startup thermal oxidizer 290.

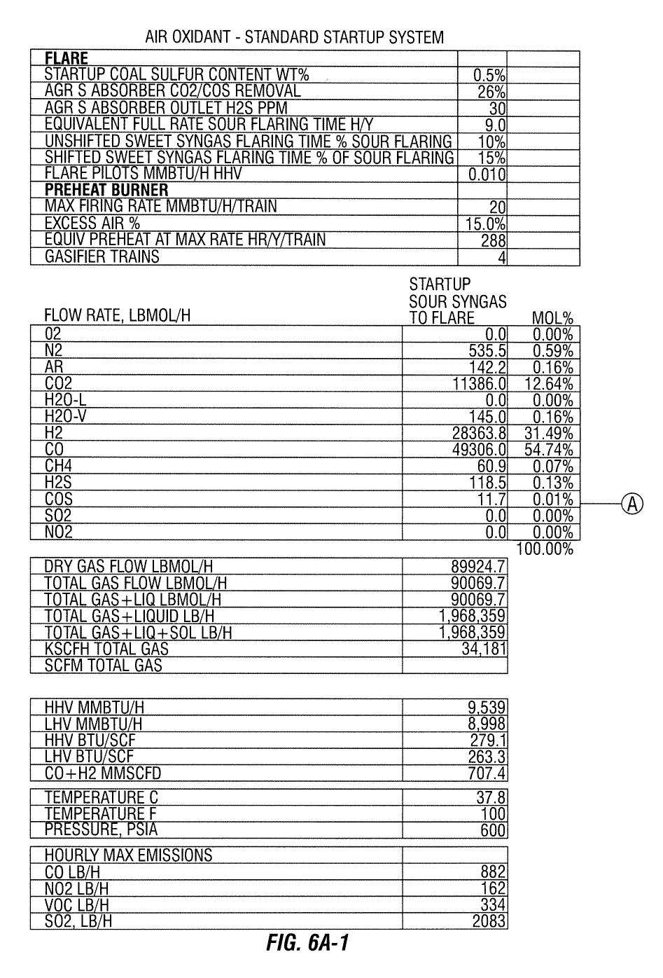

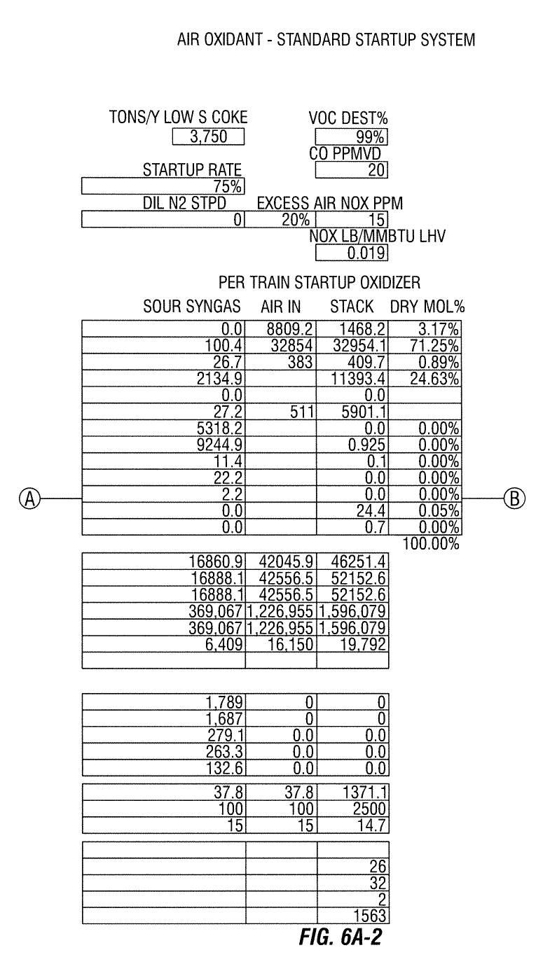

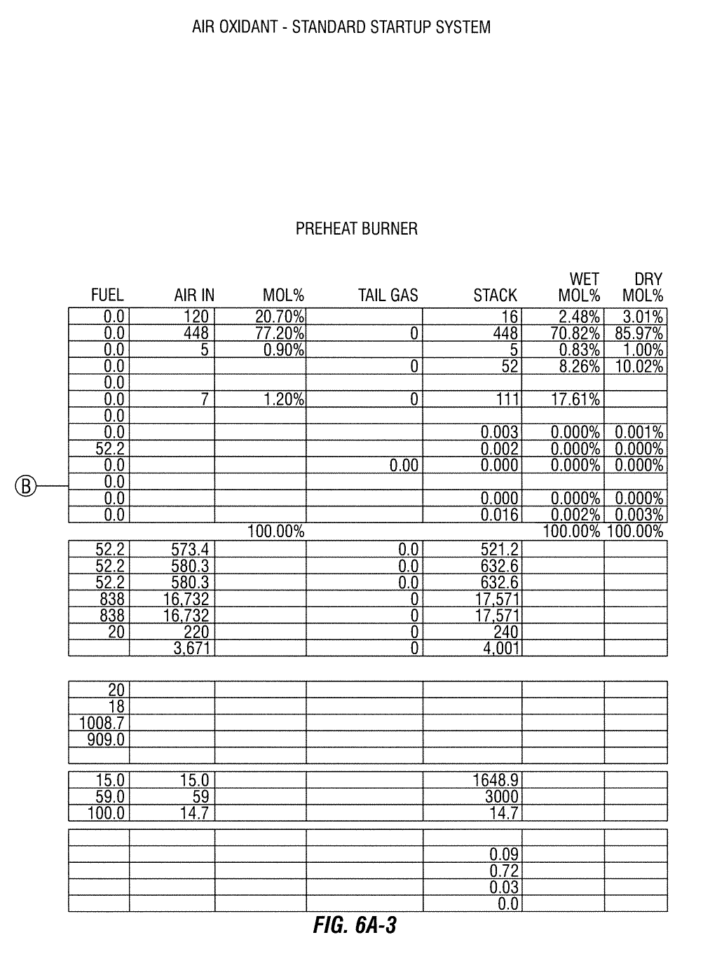

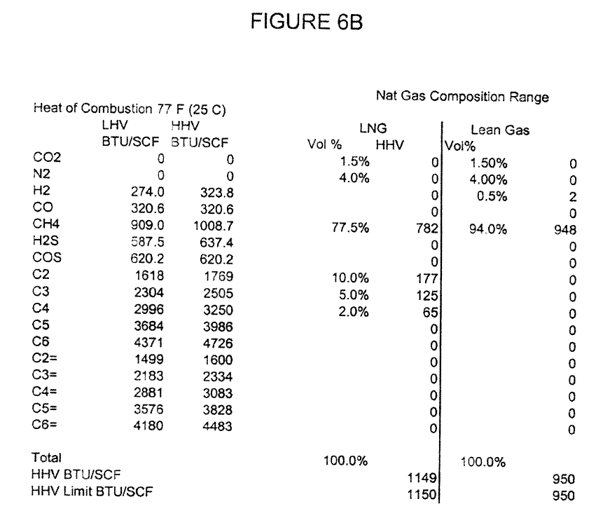

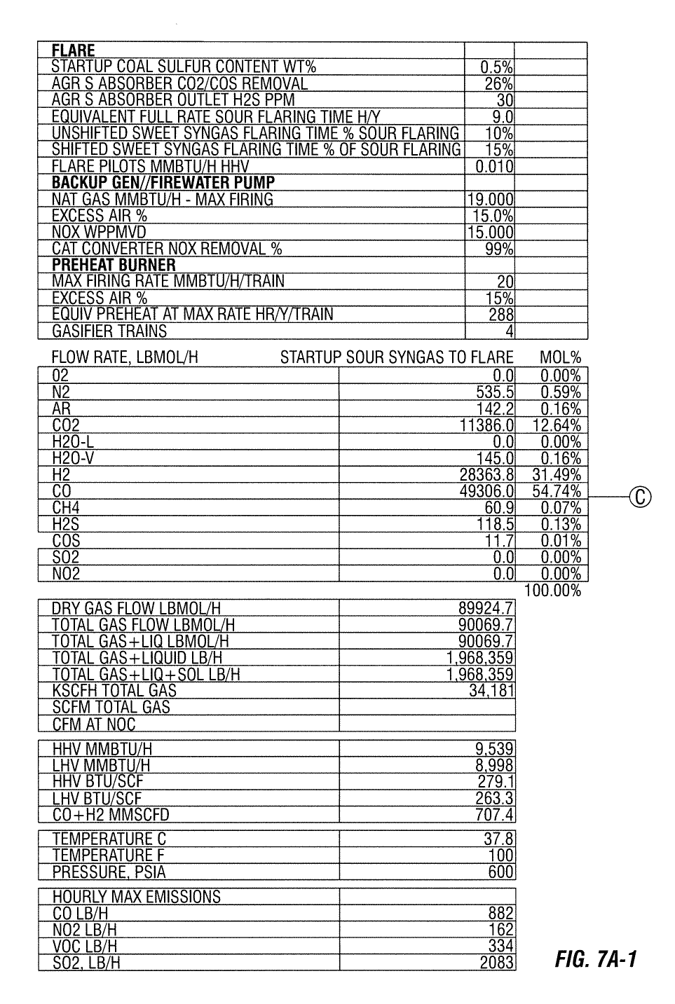

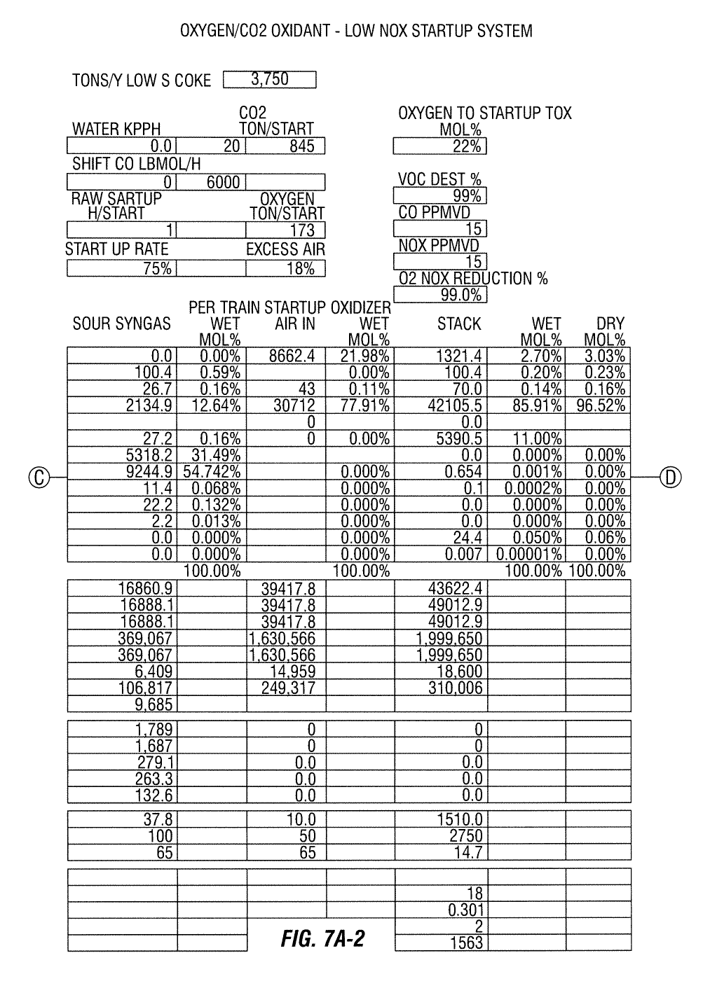

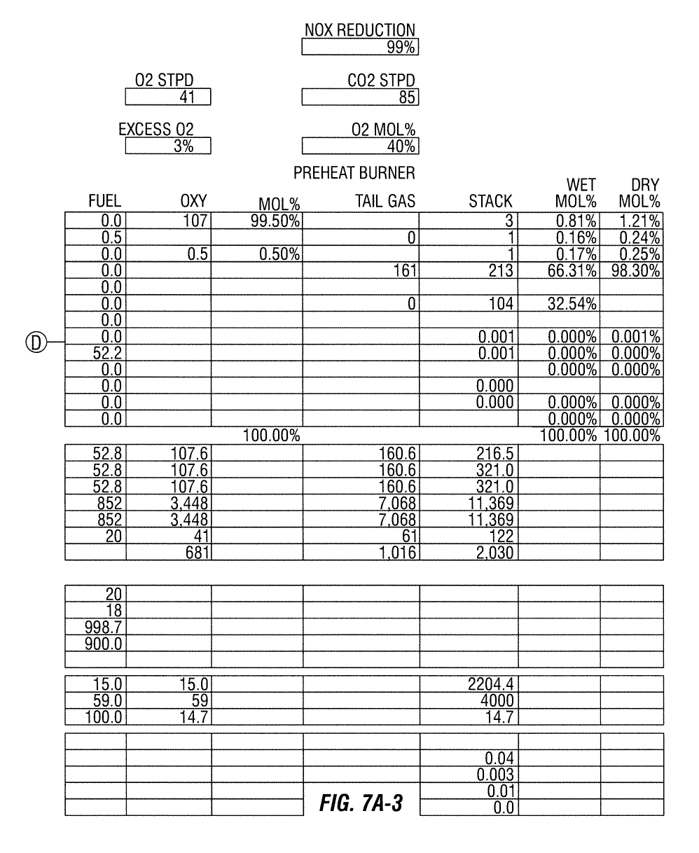

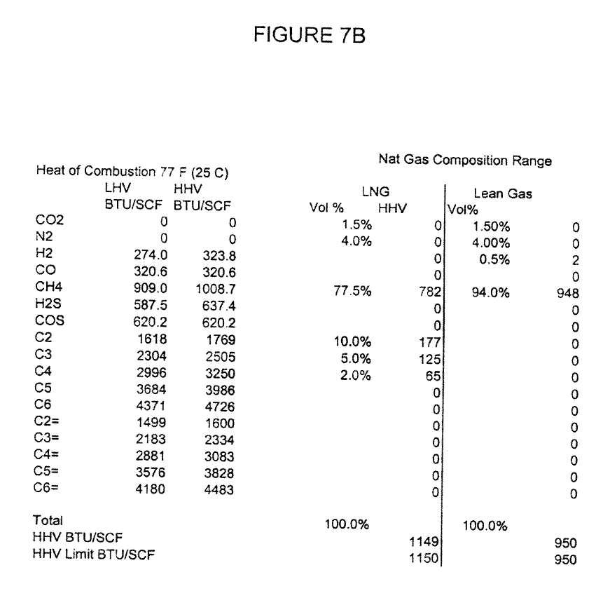

Now referring to FIG. 6A, FIG. 6B, FIG. 7A, and FIG. 7B, an emissions comparison may be made when air is used as an oxidant for combusting the gases and when the CO₂/O₂ mixture is used as the oxidant for combusting the gases. FIG. 6A shows a table providing flow specifications and hourly max emissions during the startup of the gasification unit while using an air oxidant in accordance with an exemplary embodiment. FIG. 6B shows a table providing natural gas compositions used for obtaining the table of FIG. 6A in accordance with an exemplary embodiment. FIG. 7A shows a table providing flow specifications and hourly max emissions during the startup of the gasification unit while using a CO₂/O₂ oxidant in accordance with an exemplary embodiment. FIG. 7B shows a table providing natural gas compositions used for obtaining the table of FIG. 7A in accordance with an exemplary embodiment.

FIG. 6B and FIG. 7B illustrate the natural gas compositions that are provided to the calculations made within FIG. 6A and FIG. 6B and depicts that the comparisons being made are using identical natural gas feed streams. Both FIG. 6B and FIG. 7B both show that the natural gas composition comprises 1.5% CO₂ by volume, 4.0% N₂ by volume, 77.5% methane (“CH₄”) by volume, 10.0% ethane (“C₂”) by volume, 5.0% propane (“C₃”) by volume, and 2.0% butane (“C₄”) by volume when liquefied natural gas (“LNG”) is used. When lean gas is used, the natural gas composition comprises 1.5% CO₂ by volume, 4.0% N₂ by volume, 0.5% hydrogen (H₂) by volume, and 94.0% CH₄ by volume. Thus, the values presented in FIG. 6A and FIG. 7A may be directly compared with one another. Although natural gas has been illustrated as the fuel source for the pilot gas, other fuels may be used for the pilot gas without departing from the scope and spirit of the exemplary embodiment.

With respect to FIG. 6A and FIG. 7A, in the first column set, the startup sour syngas to flare stream represents the total startup sour syngas that is produced and sent to the flare, or startup thermal oxidizer. In the second column set, the per train startup oxidizer represents the gases, sour syngas and oxidant, entering the startup thermal oxidizer and the emissions exiting the startup thermal oxidizer upon combustion of the sour syngas. The sour syngas stream of the per train startup oxidizer represents the sour syngas produced in one of the four trains, and is therefore approximately one-fourth of the total startup sour syngas that is produced and sent to the flare. In actuality, the sour syngas stream of the per train startup oxidizer is slightly less than one-fourth of the total startup sour syngas because the gasifier is not started up at full rate and each gasifier is started up independently from one another. The sour syngas stream is referred to as sour because this is the stream that is flowing from the shift reactor system to the startup thermal oxidizer, prior to the stream entering the acid gas removal system. In the third column set, the pre-heat burner, or startup pre-heat burner, represents the gases, fuel and oxidant, entering the pre-heat burner and the emissions exiting the pre-heat burner upon combustion of the gases.

As illustrated in the table of FIG. 6A when air is used as the oxidant and according to an exemplary embodiment, the total gas flow of the startup sour syngas to flare is 34,181 kilo standard cubic feet per hour (“KSCFH”). The total gas flow of the sour syngas per train startup oxidizer is 6,409 KSCFH. The total gas flow of the air entering the stack is 16,150 KSCFH, wherein the flow rate of O₂ is 8809.2 pound-mol per hour (“lbmol/hr”), the flow rate of N₂ is 32,854 lbmol/hr, the flow rate of argon is 383 lbmol/hr, and the flow rate of vaporized H₂O is 511 lbmol/hr. Since there is a high concentration of N₂ in the air stream, it follows that there is a high concentration of NOₓ that is formed and emitted from the startup thermal oxidizer. The hourly max emissions of CO is 26 pounds per hour (“lb/hr”). The hourly max emissions of NO₂ is 32 lb/hr. The hourly max emissions of VOC is 2 lb/hr. The hourly max emissions of SO₂ is 1563 lb/hr. The reason that there is a high amount of SO₂ that is emitted is because the sour syngas entering the startup thermal oxidizer has not yet proceeded through the acid gas removal system to remove the sulfur.

When air is used as the oxidant in the pre-heat burner and according to an exemplary embodiment, the total gas flow of the fuel, or CH₄, entering the pre-heat burner is 20 KSCFH. The total gas flow of the air entering the pre-heat burner is 220 KSCFH, wherein the flow rate of O₂ is 120 lbmol/hr, the flow rate of N₂ is 448 lbmol/hr, the flow rate of argon is 5 lbmol/hr, and the flow rate of vaporized H₂O is 7 lbmol/hr. Since there is a high concentration of N₂ in the air stream, there is a high concentration of NOₓ that is formed and emitted from the pre-heat burner. The hourly max emissions of CO is 0.09 lb/hr. The hourly max emissions of NO₂ is 0.72 lb/hr. The hourly max emissions of VOC is 0.03 lb/hr. The hourly max emissions of SO₂ is 0.0 lb/hr.

Alternatively, as illustrated in the table of FIG. 7A when the CO₂/O₂ mixture is used as the oxidant and according to an exemplary embodiment, the total gas flow of the startup sour syngas to flare is 34,181 KSCFH. The total gas flow of the sour syngas per train startup oxidizer is 6,409 KSCFH. The total gas flow of the CO₂/O₂ mixture entering the stack is 14,959 KSCFH, wherein the flow rate of O₂ is 8662.4 lbmol/hr, the flow rate of argon is 43 lbmol/hr, and the flow rate of CO₂ is 30,712 lbmol/hr. Since there is little to no concentration of N₂ in the CO₂/O₂ mixture stream, there is a very low concentration of NOₓ that is formed and emitted from the startup thermal oxidizer. The hourly max emissions of CO is 18 lb/hr. The hourly max emissions of NO₂ is 0.301 lb/hr. The hourly max emissions of VOC is 2 lb/hr. The hourly max emissions of SO₂ is 1563 lb/hr. The reason that there is a high amount of SO₂ that is emitted is because the sour syngas entering the startup thermal oxidizer has not yet proceeded through the acid gas removal system to remove the sulfur.

When the CO₂/O₂ mixture is used as the oxidant in the pre-heat burner and according to an exemplary embodiment, the total gas flow of the fuel, or CH₄, entering the pre-heat burner is 20 KSCFH. The total gas flow of the CO₂/O₂ mixture entering the pre-heat burner is 102 KSCFH, wherein the flow rate of O₂ is 107 lbmol/hr, the flow rate of argon is 0.5 lbmol/hr, and the flow rate of CO₂ is 161 lbmol/hr. Since there is little to no concentration of N₂ in the CO₂/O₂ mixture stream, it follows that there is a very low concentration of NOₓ that is formed and emitted from the pre-heat burner. The hourly max emissions of CO is 0.04 lb/hr. The hourly max emissions of NO₂ is 0.003 lb/hr. The hourly max emissions of VOC is 0.01 lb/hr. The hourly max emissions of SO₂ is 0.0 lb/hr.

In summary, when using the CO₂/O₂ mixture, instead of air, as the oxidant, emissions of CO, NOₓ, and VOCs are substantially decreased. In the per train startup oxidizer, emissions of CO decreased from 26 lb/hr when using air to 18 lb/hr when using the CO₂/O₂ mixture, which is approximately a 31% decrease. Emissions of NOₓ decreased from 32 lb/hr when using air to 0.301 lb/hr when using the CO₂/O₂ mixture, which is approximately a 99% decrease. In the pre-heat burner, emissions of CO decreased from 0.09 lb/hr when using air to 0.04 lb/hr when using the CO₂/O₂ mixture, which is approximately a 56% decrease. Emissions of NOₓ decreased from 0.72 lb/hr when using air to 0.003 lb/hr when using the CO₂/O₂ mixture, which is approximately a 99.6% decrease. Emissions of VOCs decreased from 0.03 lb/hr when using air to 0.01 lb/hr when using the CO₂/O₂ mixture, which is approximately a 67% decrease.

Thus, many of the emissions are significantly reduced. One reason that there is a reduction in NOₓ formation when using the CO₂/O₂ mixture as the oxidant, rather than air, is that much less nitrogen is introduced in the combustion process. Another reason includes the fact that oxygen is not placed into the flame itself. One reason that there is a reduction in CO and VOCs formation when using the CO_{2/O}₂ mixture as the oxidant, rather than air, is that the flame temperature may be controlled better. The O₂ provides the oxidant in order to burn the gases, while CO₂ acts as a heat sink to absorb the heat from the reaction so that the flame temperature does not become too hot. The N₂ in the air also behaves as a heat sink, but CO₂ performs much better as a heat sink. Secondly, the O₂ content may be increased within the oxidant so as to reduce the CO formation. Additionally, since the reaction initiates at the bottom portion of the startup thermal oxidizer, or combustion zone, there is a longer residence time within the pipe for the hot gases to continue to react with one another before the gases are discharged into the atmosphere.

By significantly reducing NOₓ formation, the costs associated with NOₓ formation, in the form of environmental regulations and the purchasing and selling of NOₓ credits, may also be significantly reduced. As shown above in one example, NOₓ emissions may be reduced from about 30 lb/hr to about 0.3 lb/hr when using the CO₂/O₂ mixture as the oxidant, rather than air. This corresponds to a yearly reduction from about 140 tons of NOₓ per year (“TPY”) to about 1.5 TPY on a 8760 hours per year (“h/y”) basis. Since the market value of NOₓ credits may be over $200,000 per ton of NOₓ, the savings would be over $27.7 million in a year.

Another effect of using the CO₂/O₂ mixture as the oxidant, rather than air, is that the O₂ concentration in the oxidant may be increased, when compared to air. This increase in O₂ content allows the combustion flame to reach the higher temperatures at a faster rate, which then allows for less natural gas consumption. For example, natural gas is used to pre-heat the startup pre-heat burner and if the time for pre-heating decreases, it follows that less natural gas will be used. Thus, additional savings may be achieved when using this CO₂/O₂ mixture as the oxidant.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims. It is therefore, contemplated that the claims will cover any such modifications or embodiments that fall within the scope of the invention.

What is claimed is:

1. A low NOₓ startup system, comprising:
a combustion device;
an O₂ stream entering the combustion device; and
a CO₂ stream entering the combustion device;
wherein the O₂ stream and the CO₂ stream are combined to form a CO₂/O₂ mixture comprising a CO₂ composition and an O₂ composition.

2. The low NOₓ startup system of claim 1, wherein the CO₂ composition within the CO₂/O₂ mixture ranges from about 75% to about 80% and the O₂ composition within the CO₂/O₂ mixture ranges from about 20% to about 25%.

3. The low NOₓ startup system of claim 1, wherein the CO₂ composition within the CO₂/O₂ mixture ranges from about 65% to about 85% and the O₂ composition within the CO₂/O₂ mixture ranges from about 15% to about 35%.

4. The low NOₓ startup system of claim 1, wherein the combustion device is a startup pre-heat burner, the startup pre-heat burner being coupled to a gasifier.

5. The low NOₓ startup system of claim 1, wherein the combustion device is a startup thermal oxidizer, the startup thermal oxidizer receiving an off-spec syngas.

6. The low NOₓ startup system of claim 1, wherein the O₂ stream is a vapor O₂ stream provided from an air separation system.

7. The low NOₓ startup system of claim 1, wherein the O₂ stream is stored as a liquid O₂ in an O₂ storage tank, the O₂ storage tank being fluidly coupled to the combustion device.

8. The low NOₓ startup system of claim 7, wherein the liquid O₂ is generated within an air separation system, the air separation system being fluidly coupled to the O₂ storage tank.

9. The low NOₓ startup system of claim 1, wherein the CO₂ stream is a vapor CO₂ stream provided by from an acid gas removal system.

10. The low NOₓ startup system of claim 1, wherein the CO₂ stream is stored as a liquid CO₂ in a CO₂ storage tank, the CO₂ storage tank being fluidly coupled to the combustion device.

11. The low NOₓ startup system of claim 10, wherein the liquid CO₂ is generated within an acid gas removal system, the acid gas removal system being fluidly coupled to the CO₂ storage tank.

12. The low NOₓ startup system of claim 1, wherein the O₂ stream and the CO₂ stream are mixed together prior to entering the combustion device.

13. The low NOₓ startup system of claim 1, wherein the O₂ stream and the CO₂ stream are mixed together after entering the combustion device.

14. A low NOₓ startup system, comprising:
an air separation system, the air separation system producing a liquid O₂;
an O₂ storage tank fluidly coupled to the air separation system, the O₂ storage tank receiving and storing the liquid O₂;
an acid gas removal system, the acid gas removal system producing a liquid CO₂;
a CO₂ storage tank fluidly coupled to the acid gas removal system, the CO₂ storage tank receiving and storing the liquid CO₂; and
a combustion device fluidly coupled to the O₂ storage tank and the CO₂ storage tank, the combustion device receiving an O₂ stream from the O₂ storage tank and a CO₂ stream from the CO₂ storage tank;
wherein the O₂ stream and the CO₂ stream are combined to form a CO₂/O₂ mixture comprising a CO₂ composition and an O₂ composition.

15. The low NOₓ startup system of claim 14, wherein the CO₂ composition within the CO₂/O₂ mixture ranges from about 75% to about 80% and the O₂ composition within the CO₂/O₂ mixture ranges from about 20% to about 25%.

16. The low NOₓ startup system of claim 14, wherein the CO₂ composition within the CO₂/O₂ mixture ranges from about 65% to about 85% and the O₂ composition within the CO₂/O₂ mixture ranges from about 15% to about 35%.

17. The low NOₓ startup system of claim 14, wherein the O₂ stream and the CO₂ stream are mixed together prior to entering the combustion device.

18. The low NOₓ startup system of claim 14, wherein the O₂ stream and the CO₂ stream are mixed together after entering the combustion device.

19. A method for starting up a low NOₓ startup system, comprising:
providing a combustion device;
providing an O₂ stream to the combustion device; and
providing a CO₂ stream to the combustion device;
wherein the O₂ stream and the CO₂ stream are combined to form a CO₂/O₂ mixture comprising a CO₂ composition and an O₂ composition.

20. The method of claim 19, wherein the CO₂ composition within the CO₂/O₂ mixture ranges from about 75% to about 80% and the O₂ composition within the CO₂/O₂ mixture ranges from about 20% to about 25%.

21. The method of claim 19, wherein the CO₂ composition within the CO₂/O₂ mixture ranges from about 65% to about 85% and the O₂ composition within the CO₂/O₂ mixture ranges from about 15% to about 35%.

22. The method of claim 19, wherein the O₂ stream is a vapor O₂ stream provided from an air separation system.

23. The method of claim 19, wherein the O₂ stream is stored as a liquid O₂ in an O₂ storage tank, the O₂ storage tank being fluidly coupled to the combustion device.

24. The method of claim 23, wherein the liquid O₂ is generated within an air separation system, the air separation system being fluidly coupled to the O₂ storage tank.

25. The method of claim 19, wherein the CO₂ stream is a vapor CO₂ stream provided by from an acid gas removal system.

26. The method of claim 19, wherein the CO₂ stream is stored as a liquid CO₂ in a CO₂ storage tank, the CO₂ storage tank being fluidly coupled to the combustion device.

27. The method of claim 26, wherein the liquid CO₂ is generated within an acid gas removal system, the acid gas removal system being fluidly coupled to the CO₂ storage tank.

28. A method for starting up a low NOₓ startup system, comprising:
providing a first O₂ stream, a first CO₂ stream, and a natural gas stream to a pre-heat burner located within a gasification system;
providing a second O₂ stream and a second CO₂ stream to a thermal oxidizer;
reacting the first O₂ stream, the first CO₂ stream, and the natural gas stream within the pre-heat burner to produce an effluent stream;
upon pre-heating the pre-heat burner to a desired temperature, providing the first O₂ stream and a coal/coke stream into the gasification system to produce a scrubbed reacted gas stream;
providing the scrubbed reacted gas stream to a shift reactor system, the shift reactor system removing a substantial portion of water from the scrubbed reacted gas stream and producing a sour syngas stream;
providing the sour syngas stream to the thermal oxidizer;
reacting the second O₂ stream, the second CO₂ stream, and the sour syngas stream within the thermal oxidizer to produce a first thermal oxidizer discharge stream;
upon the shift reactor system reaching a first desired pressure, providing the sour syngas stream to an acid gas removal system to produce an off-spec syngas stream;
providing the off-spec syngas stream to the thermal oxidizer;
reacting the second O₂ stream, the second CO₂ stream, and the off-spec syngas stream within the thermal oxidizer to produce a second thermal oxidizer discharge stream; and
upon the acid gas removal system reaching a second desired pressure, producing a spec syngas stream.

29. The method of claim 28, wherein the desired temperature is an initiation temperature.

30. The method of claim 29, wherein the initiation temperature is about 2500° F.

31. The method of claim 28, wherein the first O₂ stream and the second O₂ stream are generated from an air separation system.

32. The method of claim 28, wherein the first CO₂ stream and the second CO₂ stream are generated from the acid gas removal system.
